(19) United States
(12) Patent Application Publication
(10) Pub. No.: US 2017/0131729 A1
(43) Pub. Date: May 11, 2017

(54) THERMOSTAT WITH THERMAL RADIATION DETECTOR

(71) Applicant: Carrier Corporation, Farmington, CT (US)

(72) Inventor: Keith Heigl, Winamac, IN (US)

(21) Appl. No.: 15/335,496

(22) Filed: Oct. 27, 2016

Related U.S. Application Data
(60) Provisional application No. 62/252,764, filed on Nov. 9, 2015.

(51) Int. Cl. G05D 23/27; G01J 5/12

(52) U.S. Cl. CPC G05D 23/27; G01J 5/12

(57) ABSTRACT

A thermostat includes a housing having an exterior surface and an interior surface with a view port communicating through the surfaces. A target of the thermostat is disposed outside of the housing and made of a material having a high thermal conductivity. A thermal detector housed in the housing is configured to measure a parameter indicative of at least the temperature of the target.

### CROSS-REFERENCE TO RELATED APPLICATIONS

This application claims the benefit of U.S. provisional patent application Ser. No. 62/252,764, filed Nov. 9, 2015, the entire contents of which are incorporated herein by reference.

### BACKGROUND

The present disclosure relates to a thermostat and, more particularly, to thermostat with a thermal radiation detector.

Thermostats often used in commercial and residential heating and cooling systems, as one non-limiting example, is a portion of a control system that senses temperature of, for example, the air in a room. Utilizing a pre-programmed temperature setpoint, the thermostat is configured to control the heating and cooling system by initiating heating and/or cooling components of the system to bring the room temperature at or near the pre-programmed setpoint temperature. Traditional digital thermostats may use thermistors or other semiconductor devices such as a resistance thermometer to measure room temperature. Unfortunately, traditional temperature sensors are known to have undesirable characteristics that may include a lack of accuracy, a sensitivity toward short-term transient conditions/temperatures leading to false readings, characteristics that may limit the mounting location of the thermostat (e.g., may not mount the thermostat on an exterior wall), and others. Improvements in thermostats and thermostat temperature sensors is desirable.

### SUMMARY

A thermostat according to one, non-limiting, embodiment of the present disclosure includes a housing including an exterior surface and an interior surface with a view port communicating through the surfaces; a target disposed outside of the housing and made of a material having a thermal conductivity that is higher than a thermal conductivity of the housing; and a thermal detector housed in the housing and configured to measure a parameter indicative of at least the temperature of the target.

Additionally to the forgoing embodiment, the thermal detector is a non-contact infrared detector.

In the alternative or additional thereto, in the foregoing embodiment, the non-contact infrared detector is an infrared thermopile detector.

In the alternative or additional thereto, in the foregoing embodiment, the material is metallic and the target fixed to the housing.

In the alternative or additional thereto, in the foregoing embodiment, the thermostat includes a circuit board housed within the housing and coupled to the thermal detector.

In the alternative or additional thereto, in the foregoing embodiment, the thermal detector is spaced from the interior surface.

In the alternative or additional thereto, in the foregoing embodiment, the thermostat includes a lens supported by the housing and spaced between the target and the thermal detector.

In the alternative or additional thereto, in the foregoing embodiment, a distance between the interior surface and the thermal detector is associated with a viewing angle of the thermal detector.

In the alternative or additional thereto, in the foregoing embodiment, a cross sectional area of the view port is about equal to the sensing area of the thermal detector for limiting effects of radiated heat from the circuit board.

In the alternative or additional thereto, in the foregoing embodiment, the thermal detector is an infrared detector.

In the alternative or additional thereto, in the foregoing embodiment, the material is an aluminum alloy.

In the alternative or additional thereto, in the foregoing embodiment, the thermostat includes a circuit board housed within the housing and operatively coupled to the thermal detector.

In the alternative or additional thereto, in the foregoing embodiment, the housing comprises plastic.

In the alternative or additional thereto, in the foregoing embodiment, the target is in direct thermal contact with ambient air disposed outside of the housing.

In the alternative or additional thereto, in the foregoing embodiment, the thermostat is a HVAC thermostat.

A HVAC thermostat according to another, non-limiting, embodiment includes a housing including an exterior surface and an interior surface with a view port communicating through the surfaces; a metallic target disposed outside of and supported by the housing, and covering the view port; circuitry housed by the housing and spaced from the interior surface; and an infrared thermal detector housed in the housing, operatively coupled to the circuitry, and configured to measure a parameter at least in-part indicative of the temperature of the target.

Additionally to the foregoing embodiment, the infrared thermal detector is spaced from the interior surface.

In the alternative or additionally thereto, in the foregoing embodiment, the HVAC thermostat includes a lens supported by the housing and spaced between the metallic target and the infrared thermal detector.

In the alternative or additional thereto, in the foregoing embodiment, a cross sectional area of the view port is approximate to a sensing area of the thermal detector for limiting effects of radiated heat from the circuitry.

In the alternative or additional thereto, in the foregoing embodiment, the metallic target is in direct thermal contact with ambient air disposed outside of the housing.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a front view of a thermostat as one, non-limiting, exemplary embodiment of the present disclosure;

FIG. 2 is a partial perspective cross section of the thermostat; and

FIG. 3 is a cross section of a thermal sensor assembly of the thermostat.

### DETAILED DESCRIPTION

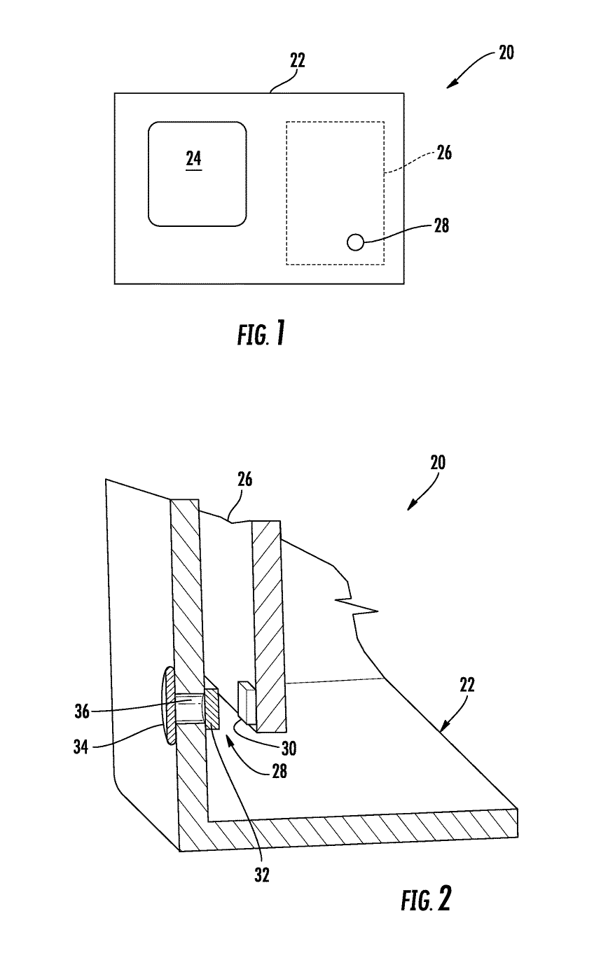

Referring to FIG. 1, a thermostat 20 as one, non-limiting, exemplary embodiment of the present disclosure is illustrated. The thermostat 20 may be part of a control system (not shown) for a heating and/or cooling system of commercial and/or residential buildings. The thermostat 20 may be mounted to a wall in a strategically placed location for monitoring surrounding ambient air temperature. One, non-limiting, example of a heating and cooling system may be a heating, ventilation, and air conditioning (HVAC) system. Other types of heating and cooling systems capable of utilizing the thermostat 20 and adapted to condition ambient air within a building may also include hydronic systems and others. The thermostat 20 may include a housing 22, a display 24, internal circuitry and/or a circuit board 26, and a temperature sensor assembly 28. The display 24 may be any type of display generally known in the art and may be configured to display real-time ambient air temperature, setpoint temperature, the current mode and/or operating state of the heating and cooling system and other information. The display 24 may be an interactive touch screen enabling a user to pre-program the temperature setpoint and other features generally known in the art.

The circuit board 26 is housed within the housing 22 and may include a microprocessor and other circuitry configured to receive programmable inputs from a user, via for example, the touchscreen display 24, and output various commands to the heating and cooling system. The temperature sensor assembly 28 is operatively coupled to the circuit board 26 for sending temperature data indicative of the surrounding ambient air temperature.

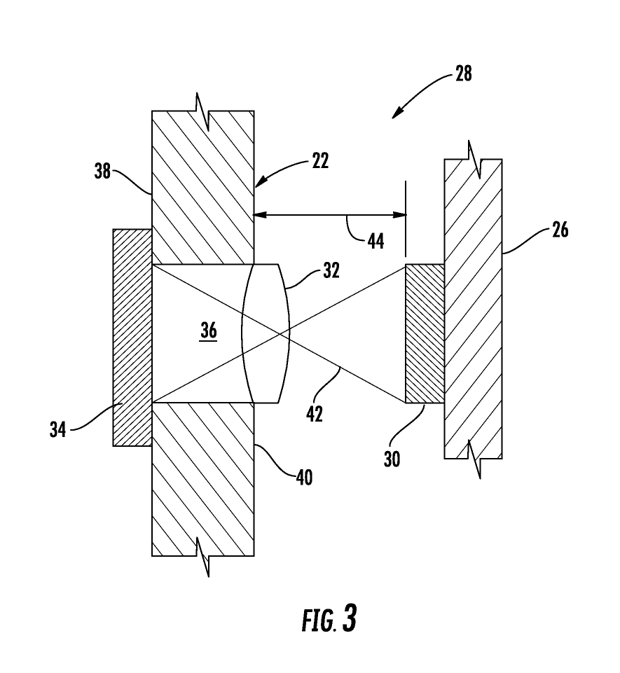

Referring to FIG. 2, the temperature sensor assembly 28 may include a temperature detector 30, a lens 32 and a target 34, all proximate to a view port 36 that may communicate through the housing 22. The temperature detector 30 may be a non-contact thermal radiation thermometer adapted to measure thermal radiation emitted by the target 34. One example of a thermal radiation thermometer may be an infrared temperature detector. The lens 32 of the temperature sensor assembly 28 is constructed and arranged to focus the thermal radiation (e.g., infrared thermal radiation) emitted by the target 34 onto the detector 30. The detector 30 may then convert the thermal radiation (i.e., thermal power) to an electrical signal sent to the circuit board 26.

Referring to FIGS. 2 and 3, the housing 22 may be made of a material having thermal conductivity that is substantially less than the thermal conductivity of the target 34. One example of a housing material is plastic. The housing 22 may include an external surface 38 and an opposite internal surface 40. The external surface 38 is generally exposed to the surrounding ambient air of, for example, a room of a building. The view port 36 may extend between and communicate through the surfaces 38, 40. The circuit board 26 is spaced from the internal surface 40 of the housing 22. The target 34 may be fixed and/or proximate to the external surface 38 and covers the view port 36. The target 34 is made of a material that has a high thermal conductivity. Examples of such materials include aluminum or aluminum alloys, copper, gold and other metallic materials.

The lens 32 is generally aligned to the view port 36 and spaced between the target 34 and the detector 30. In one example, the lens 32 may be proximate to the internal surface 40 and generally covers the view port 36. The lens 32 is configured and located to create a viewing angle 42 where substantially all of a detection area of the detector is utilized and measures substantially all of the surface area of the target 34 exposed within the view port 36. More specifically, it is desirable to maintain a cross section of the view port 36 at a minimum to limit any negative effects of thermal radiation emitted from the circuit board. Therefore, it is desirable to view substantially all of the target area exposed through the view port 36 (i.e., or otherwise reduce the view port size and measure only a portion of the target).

The viewing angle 42 may be associated with a distance 44 measured between the detector 30 and the inward surface 40 of the housing 22 proximate to the view port 36. The combination of the angle 42 and the distance 44 generally determines the viewing port 36 size to use, or alternatively, the lens 32 to use for a given view port 36 size. It is further contemplated and understood that the lens 32 may not be required, although some distance between the target 34 and the detector 30 is maintained. Furthermore, the cross sectional area of the view port 36 may be substantially equal to the detection area of the detector 30. That is, having a detection area larger than the view port would render a portion of the detector inactive. By minimizing the view port area, any undesired effects of radiated energy emanating from the circuit board 26 may be minimized. It is desirable that the target material mimics the outside temperature as closely as possible without any self-generated thermal interference from the internal circuitry.

The detector 30 may be an infrared thermopile detector. The detector 30 may include a plurality of thermocouples that may be connected in series. In this example, the detector 30 absorbs passive infrared energy from the target 34 at wavelengths within a range of about two (2) micrometers to twenty (20) micrometers and within a predefined field of view. The detector 30 may not respond to absolute temperature, and instead, may measure a difference in temperature between the target temperature and a temperature internal to the housing 22. More specifically, a math engine may be applied that is internal to the detector 30 or part of the programming of the circuit board 26. The math engine may generally combine the corresponding change in a parameter (e.g., voltage) across the detector 30 with an internal reference temperature sensor (not shown) of the detector 30. Alternatively, the detector 30, when mounted to the circuit board 26 may measure the difference between the target 34 temperature and the circuit board 26 temperature (i.e., the reference temperature) as a change in voltage.

Benefits of the present disclosure include a sensor assembly 28 that is generally not thermally isolated from the associated circuit board 26 that carries the detector 30 of the assembly 28. Yet further, the sensor assembly 28 can determine the temperature of a dissociated target while minimizing the effect of conducted thermal energy. Additionally the plastic housing 22 may isolated the metallic target 34 from the internally generated heat while allowing for direct thermal contact with the ambient air. An analog-to-digital converter may minimize variability due to noise interference.

While the present disclosure is described with reference to exemplary embodiments, it will be understood by those skilled in the art that various changes may be made and equivalents may be substituted without departing from the scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A thermostat comprising:
a housing including an exterior surface and an interior surface with a view port communicating through the surfaces;
a target disposed outside of the housing and made of a material having a thermal conductivity that is higher than a thermal conductivity of the housing; and
a thermal detector housed in the housing and configured to measure a parameter indicative of at least the temperature of the target.

2. The thermostat set forth in claim 1, wherein the thermal detector is a non-contact infrared detector.

3. The thermostat set forth in claim 2, wherein the non-contact infrared detector is an infrared thermopile detector.

4. The thermostat set forth in claim 1, wherein the material is metallic and the target fixed to the housing.

5. The thermostat set forth in claim 1 further comprising:
a circuit board housed within the housing and coupled to the thermal detector.

6. The thermostat set forth in claim 5, wherein the thermal detector is spaced from the interior surface.

7. The thermostat set forth in claim 1 further comprising:
a lens supported by the housing and spaced between the target and the thermal detector.

8. The thermostat set forth in claim 7, wherein a distance between the interior surface and the thermal detector is associated with a viewing angle of the thermal detector.

9. The thermostat set forth in claim 8, wherein a cross sectional area of the view port is about equal to the sensing area of the thermal detector for limiting effects of radiated heat from the circuit board.

10. The thermostat set forth in claim 9, wherein the thermal detector is an infrared detector.

11. The thermostat set forth in claim 10, wherein the material is an aluminum alloy.

12. The thermostat set forth in claim 10 further comprising:
a circuit board housed within the housing and operatively coupled to the thermal detector.

13. The thermostat set forth in claim 10, wherein the housing comprises plastic.

14. The thermostat set forth in claim 10, wherein the target is in direct thermal contact with ambient air disposed outside of the housing.

15. The thermostat set forth in claim 1, wherein the thermostat is a HVAC thermostat.

16. A HVAC thermostat comprising:
a housing including an exterior surface and an interior surface with a view port communicating through the surfaces;
a metallic target disposed outside of and supported by the housing, and covering the view port;
circuitry housed by the housing and spaced from the interior surface; and
an infrared thermal detector housed in the housing, operatively coupled to the circuitry, and configured to measure a parameter at least in-part indicative of the temperature of the target.

17. The HVAC thermostat set forth in claim 16, wherein the infrared thermal detector is spaced from the interior surface.

18. The HVAC thermostat set forth in claim 17 further comprising:
a lens supported by the housing and spaced between the metallic target and the infrared thermal detector.

19. The thermostat set forth in claim 18, wherein a cross sectional area of the view port is approximate to a sensing area of the thermal detector for limiting effects of radiated heat from the circuitry.

20. The thermostat set forth in claim 19, wherein the metallic target is in direct thermal contact with ambient air disposed outside of the housing.
